(19) United States
(12) Patent Application Publication
(10) Pub. No.: US 2025/0261787 A1
(43) Pub. Date: Aug. 21, 2025

(54) Beverage Maker With Controllable Operation And Method For Controlling The Operation Of A Beverage Maker

(71) Applicant: WMF GmbH, Geislingen An Der Steige (DE)

(72) Inventors: Oliver Schneider, Geislingen An Der Steige (DE); Armin Startz, Weidenstetten (DE); Stephan Joos, Geislingen An Der Türkheim (DE)

(73) Assignee: WMF GmbH, Geislingen An Der Steige (DE)

(21) Appl. No.: 19/027,034

(22) Filed: Jan. 17, 2025

(30) Foreign Application Priority Data
Jan. 17, 2024 (DE) 10 2024 200 388.3

(51) Int. Cl. A47J 31/52; A47J 31/46

(52) U.S. Cl. CPC A47J 31/525; A47J 31/461; A47J 31/467; A47J 2203/00

(57) ABSTRACT

A beverage maker with controllable operation includes: a brewing unit, a storage container for at least one beverage; at least one detection unit for detecting a fill level in the storage container; a quantity of beverage brewed in the brewing unit and/or a quantity of beverage consumed by the user; an evaluation unit which communicates with the at least one detection unit and is configured such that it evaluates the data transmitted by the detection unit and determines therefrom the quantity of new beverage to be brewed; and a control unit for controlling the quantity of beverage to be brewed in the brewing unit to the desired filling quantity in the storage container based on the evaluation result of the evaluation unit.

### CROSS-REFERENCE TO RELATED APPLICATIONS

This application claims priority from German application number 10 2024 200 388.3, filed Jan. 17, 2024, the disclosure of which is hereby incorporated herein by reference.

### FIELD OF THE INVENTION

The present invention relates to a beverage maker with controllable operation and to a method for controlling the operation of a beverage maker comprising a brewing unit, a storage container for at least one beverage, at least one detection unit for detecting a fill level in the storage container, a quantity of beverage brewed in the brewing unit and/or a quantity of beverage consumed by the user, an evaluation unit which communicates with the at least one detection unit and is configured such that it evaluates the data transmitted by the detection unit and determines therefrom the quantity of new beverage to be brewed, and a control unit for controlling the quantity of beverage to be brewed in the brewing unit to a desired filling quantity in the storage container based on the evaluation result of the evaluation unit. The invention also relates to a method for controlling the operation of a beverage maker.

### BACKGROUND OF THE INVENTION

In order to increase the dispensing capacity of a coffee machine, coffee is not only brewed and dispensed cup by cup in individual brews, but is usually also brewed in larger quantities (batches) of, e.g., 0.5 L or 1 L in a storage container and stored there for dispensing. This has the advantage that dispensing may then take place independently of coffee brewing, i.e., the time required for brewing is irrelevant for dispensing. Dispensing may be dosed or undosed, i.e., by manually starting or stopping the dosing. The storage quantities are usually between 0.5 L and 5 L. The storage containers are usually insulated and often have active heating for hot coffee to keep the beverage warm during storage. However, no heating is required for cold coffee beverages. This means that both hot and cold beverages may be brewed and stored.

The fill level may be monitored with fill level probes, for example. In the simplest form, these are probes that monitor the minimum and maximum levels. When the minimum fill level set in the beverage maker or specified by the user is reached, a re-brewing process is triggered to refill the container.

The detection of the storage time as an indicator of coffee freshness is already known from EP 3 718 445 A 1 and DE 10 2014 211 094 A 1. This also describes a control system that controls a coffee machine depending on its use.

EP 3 718 445 A 1 discloses a self-learning coffee machine. Switch-on and switch-off times, stand-by mode, beverage type and parameters are recorded and evaluated using AI in order to determine and define future switch-on and switch-off times, stand-by mode, beverage types and beverage parameters.

DE 10 2014 211 094 A 1 discloses the recording of a user profile and uses this to calculate the probability of future use. Future use is calculated from current use and a probability profile, and appropriate operating parameters and a menu selection are provided to allow the possibility of cleaning. The probability profiles are stored in a cloud, evaluated and made available via the Internet, LAN or WLAN.

### SUMMARY OF THE INVENTION

Based on this, it was the object of the present invention to provide a beverage maker which enables the filling of the storage container to be controlled with regard to coffee quality, storage time and coffee waste due to excessive storage.

This object is achieved by the beverage maker with controllable operation with the features of claim 1 and the method for controlling the operation of a beverage maker with the features of claim 7. The further dependent claims describe advantageous developments.

### DETAILED DESCRIPTION OF THE INVENTION

According to the invention, a beverage maker with controllable operation is provided, which comprises the following components:
a) a brewing unit,
b) a storage container for at least one beverage,
c) at least one detection unit for detecting a fill level in the storage container, a quantity of beverage brewed in the brewing unit and/or a quantity of beverage consumed by the user,
d) an evaluation unit which communicates with the at least one detection unit and is configured such that it evaluates the data transmitted by the detection unit and determines therefrom the quantity of new beverage to be brewed, and
e) a control unit for controlling the quantity of beverage to be brewed in the brewing unit to a desired filling quantity in the storage container based on the evaluation result of the evaluation unit.

It is preferred that the at least one detection unit comprises or consists of an active sensor system (i.e., a sensor), wherein the active sensor system (i.e., the sensor) is selected in particular from the group consisting of fill level sensors, fill level probes and combinations thereof.

Alternatively or additionally, it is preferred that the detection unit has a passive sensor system, wherein this is based on a calculation, in particular via an algorithm. The passive sensor system is preferably configured to calculate a quantity of beverage (e.g. quantity of coffee) flowing into the storage container and/or flowing out of the storage container. Particularly preferably, the passive sensor system is configured to calculate a first mathematical product from an opening duration of a first valve of the beverage maker and a first volume flow of beverage (e.g., coffee) through the first valve and into the storage container and to calculate a second mathematical product from an opening duration of a second valve of the beverage maker and a second volume flow of beverage (e.g., coffee) through the second valve and out of the storage container. In particular, the passive sensor system is configured to determine a quantity of beverage (e.g., quantity of coffee) available in the storage container from a difference between the first and second mathematical product. For example, it does this by knowing how long (in terms of time) a valve through which coffee flows into the storage container has been open. It is also known how high the volume flow of the coffee is when it flows into the storage container. This allows the amount of coffee flowing into the storage container to be calculated, for example by integrating the volume flow (ml/s) over time(s). The same may be calculated for the outflowing coffee, i.e., coffee dosed into the storage container and/or disposed of. The difference between the amount of coffee that has flowed in and the amount that has flowed out is the amount of coffee still available in the storage container.

A preferred embodiment provides that the control unit is formed in such a way that various basic settings are stored in the control unit, wherein these basic settings may be manually changed by a user with regard to selectable parameters and may be set as at least one operating mode. The at least one operating mode is therefore created by the user manually setting the basic settings.

The parameters for manually setting or changing the basic setting(s) with regard to the at least one operating mode preferably comprise values that directly or indirectly indicate performance, coffee quality and coffee waste. The coffee waste inevitably results from the other two values.

Various operating modes, which result depending on the weighting or characteristics based on the selected parameters, are, for example, a full load mode (which may also include intermediate loads in its characteristics, such as a partial load), a fresh mode and an efficiency mode, wherein transition modes may also be set between these operating modes. Thus, an operating mode which is selected from the group consisting of full load mode, fresh mode and efficiency mode may be set as the at least one operating mode, wherein transition modes may also be set between these operating modes, and wherein the fresh mode in particular comprises mixing an older brewing batch located in the storage container with freshly brewed beverage (e.g., coffee). The advantage is that the option of selecting such a fresh mode ensures that fresh beverages are obtained from the beverage maker on the one hand and prevents beverages from being wasted on the other, thus making the operation of the beverage maker more economical.

One difference between a basic setting and an operating mode is that the operating mode results from a change to the selected basic setting.

The coffee quality may also be referred to as the degree of freshness, to which a specific value is assigned, wherein this is preferably determined by calculation. The value may preferably be available as a function of the time and the brewing quantity. For example, a freshly brewed batch of coffee may have a freshness level of 1.0. This value may become smaller over time, for example by multiplying it by the stored function. If, for example, the older brewing batch in the storage container is mixed with freshly brewed coffee over time, this would in turn lead to an increase in the degree of freshness. Therefore, when determining the current degree of freshness, the amount of coffee added and the amount removed must always be taken into account.

It is further preferred that the beverage maker, preferably the evaluation unit of the beverage maker, based on previous consumption values in relation to a quantity of a beverage consumed by the user, generates an AI-supported prediction of future consumption values in relation to a quantity of a beverage consumed by the user, wherein the future consumption values are generated as a function of measurement data from at least one measuring unit relating to ambient parameters, wherein the at least one measuring unit is preferably formed such that, as an ambient parameter, a parameter selected from the group consisting of season, time, ambient temperature, location, weather, traffic situation in the vicinity of the beverage maker, and combinations of these parameters is/are detectable. Particularly preferably, all of these parameters are detectable. The advantage of this embodiment is that a quantity of the at least one beverage that is provided in the storage container of the beverage dispenser may be based on the prediction of future consumption values and may therefore be “tailored” to future consumption values. This makes it easier to ensure that the at least one beverage (e.g., coffee) is available in the storage container in a short storage time and therefore in high quality, and that waste of the at least one beverage due to excessive storage is reduced or even non-existent.

Alternatively or in addition to the AI-supported prediction, the prediction of future consumption values in relation to a quantity of a beverage consumed by the user may also be made by the beverage maker, preferably by the evaluation unit of the beverage maker, on the basis of mathematical calculations (i.e., arithmetically), for example on the basis of a weighted averaging. In this case, too, the future consumption values may be generated as a function of measurement data from at least one measuring unit relating to ambient parameters, wherein the at least one measuring unit is preferably formed such that a parameter selected from the group consisting of the time of year, time of day, ambient temperature, location, weather, traffic situation in the vicinity of the beverage dispenser, and combinations of these parameters is/are detectable as an ambient parameter. Particularly preferably, all of these parameters are detectable. This embodiment may also better ensure that the at least one beverage (e.g., coffee) is available in the storage container in a short storage time and thus in high quality and that waste of the at least one beverage due to excessively long storage is reduced or even non-existent.

The averaging process may proceed as follows, for example: beverages of the same type (for example espresso, filter coffee, etc.) that were called up in the past-based on a current point in time—are taken into account, wherein only those beverages that were dispensed on the same day of the week and at the same time are considered. For example, beverages that are more than a week in the past are weighted less heavily. The weighting may be set as required in terms of time and its characteristics. Optionally, data on beverages produced on other machines may also be taken into account. For example, these beverages are also weighted less heavily.

Thus, according to the invention, the filling and the filling quantity are not only controlled via the fill level or the time, but several parameters are taken into account. For this purpose, the following modes are taken into account, which are based on a basic setting, but may also be freely defined by the user in a predefined range, namely within the scope of the described parameters:
Full load mode

The storage container is always filled to the maximum to ensure the highest dispensing speed at all times.

If the threshold value that triggers a re-brewing process is set to a high value, e.g. with a 4 L storage container and 0.5 L as the largest re-brewing batch, a threshold value of, e.g., 3.5 L may be set. This ensures that re-brewing may be carried out immediately after a beverage has been dispensed in order to achieve maximum filling. The quantity of re-brewing batches may also be dynamically controlled. If a smaller quantity is removed, a smaller brewing batch is re-brewed immediately. If a larger quantity or several quantities are removed in a shorter time, the batch size is adjusted accordingly. A modified, e.g. weakened, full load mode could only fill the storage container with a minimum quantity and an interruption due to re-brewing is only accepted for larger quantities.
Fresh mode

The fresh mode works with very short storage times in order to always dispense the maximum amount of fresh coffee. When a predefined minimum freshness level is reached, which corresponds to a freshness value of 80%, for example, a message may be sent to the user or the storage container may be emptied automatically and fresh coffee may then be brewed. A modified freshness mode, in which, for example, a preset threshold value for freshness is set at 50%, has the longest possible storage time, wherein a decline in coffee quality is accepted. In fresh mode, the coffee quality or degree of freshness is defined so that freshly brewed and dispensed coffee is of the best quality. Over time, this coffee quality continues to deteriorate, as the volatile aromas that make up the taste of fresh coffee escape over time when coffee is kept warm. Depending on an individual's sense of taste and quality awareness, clear differences as compared to a freshly brewed coffee will be noticed after 1 to 2 hours.

The control system not only takes into account the fill level of the storage container, but also the prevailing quality of the coffee. This is done via the degree of freshness or freshness factor, which is a time-dependent function. The freshness factor is a type of virtual sensor here that may also have a threshold value and triggers the at least partial emptying of the storage container. The freshness factor is a calculated value here that is not changeable by the user, however a threshold value may be set.

The quality in the storage container may be maintained at a certain level over a longer period of time by partial emptying and re-brewing. This may also be achieved by dynamic brewing batches, i.e., if a certain quantity of coffee has already been stored for 90 minutes, a certain quantity of fresh coffee is brewed in addition, so that by mixing the two quantities of coffee, a freshness factor is achieved for the total quantity that corresponds to a storage time of 45 minutes.
Efficiency mode

In efficiency mode, as little coffee as possible should be wasted or emptying of the storage container is accepted. For example, the threshold value that triggers re-brewing may be set to a low value of 0.3 L for a 4 L storage container. Re-brewing then takes place with the most efficient batch size and minimal coffee loss. With extreme concessions to the coffee quality, it would also be possible to use up the entire stored quantity before re-brewing in order to avoid or minimize coffee loss.

The three modes described correlate with each other and are stored in the beverage maker with default values in the control unit as a basic setting, but may be individually changed by the user within a predefined range based on the parameters. The user may enter the three parameters in different ways. This means that alphanumeric information (e.g. min, medium, max), numeric information (e.g. number range 1 to 10) or graphical information (e.g. a sliding bar that may be set using mechanical buttons or touchscreen buttons) may be used.

The following weighting factors are used to control demand-based filling:
Creation of consumption profiles over a rolling period (daily, weekly, monthly, annually or seasonally). Seasonally may be understood as, e.g., summer operation, winter operation, as well as, e.g., beer garden open or closed or vacation time yes/no.
At least one profile is created or customized. The rolling detection of consumption values enables automatic adjustment to changes in consumption behavior. Optionally, this may be learned by the coffee machine itself by detection and evaluation using AI or weighted averaging.

In addition to the consumption profiles, other features such as weather, traffic reports, e.g., traffic situation via Google Maps, observations of the surroundings (coffee machine, building, parking lot) may be added optionally.

This information may now be used to control the filling of the storage container as required, i.e., it is possible to determine how much coffee needs to be pre-brewed. Variable threshold values may be set for full and empty. Periods may be determined during which the storage tank is not required and is available for automatic cleaning or rinsing so that it is then ready for the next scheduled use.

It is further preferred that the beverage maker has an evaluation unit for the AI-supported prediction and/or for the prediction based on mathematical calculations, in particular based on weighted averaging, which evaluation unit communicates with the measuring unit and is configured such that it evaluates the data transmitted by the measuring unit and uses it to determine the quantity of new beverage to be brewed. It is thus preferred that the evaluation unit of the beverage maker is structured (respecitively configured) such that it evaluates the data transmitted by the detection unit and evaluates the data transmitted by the measuring unit and determines therefrom (i.e., from the evaluated data of the detection unit and the measuring unit) the quantity of new beverage to be brewed.

Preferably, the storage container has an insulation, and is arranged in the beverage maker or connected to the beverage maker as an external storage container.

According to the invention, a method for controlling the operation of a beverage maker is also provided, wherein the beverage maker has the following components:
a) a brewing unit,
b) a storage container for at least one beverage,
c) at least one detection unit for detecting a fill level in the storage container, a quantity of beverage brewed in the brewing unit and/or a quantity of beverage consumed by the user,
d) an evaluation unit communicating with the at least one detection unit, and
e) a control unit for controlling the quantity of beverage to be brewed in the brewing unit.

In the method according to the invention, the evaluation unit evaluates the data transmitted by the detection unit and uses it to determine the quantity of new beverage to be brewed. The control unit then adjusts the quantity of beverage to be brewed in the brewing unit to the desired filling quantity in the storage container based on the evaluation result of the evaluation unit.

The control unit therefore directly or indirectly detects the quantity of beverage to be brewed and/or the quantity of brewed beverage to be disposed of.

The method may comprise that various basic settings are stored in the control unit, wherein these basic settings are changed by the user with regard to selectable parameters and are set as at least one operating mode.

It is preferred that at least one operating mode is stored as a basic setting in the control unit and/or that the basic setting, which improves performance or the degree of freshness, for example, is changed with regard to various weighted parameters.

Alternatively or additionally, the at least one operating mode represents a full load mode, a fresh mode and/or an efficiency mode of the beverage maker, wherein preferably a first operating mode replicates (or represents) a full load mode, a second operating mode replicates (or represents) a fresh mode and a third operating mode replicates (or represents) an efficiency mode, wherein transition modes may also be set between these operating modes. Thus, an operating mode which is selected from the group consisting of full load mode, fresh mode and efficiency mode may be set as the at least one operating mode, wherein preferably transition modes are also set between these operating modes, and wherein the fresh mode in particular comprises mixing an older brewing batch located in the storage container with freshly brewed beverage (e.g., coffee).

It is preferred that the beverage maker, preferably the evaluation unit of the beverage maker, generates an AI-supported prediction of future consumption values in relation to a quantity of a beverage consumed by the user based on previous consumption values in relation to a quantity of a beverage consumed by the user, and/or by the beverage maker, preferably by the evaluation unit of the beverage maker, a prediction of future consumption values in relation to a quantity of a beverage consumed by the user is made on the basis of mathematical calculations, for example weighted averaging. The consumption values may (for example in the AI-supported prediction) be generated as a function of measurement data from at least one measuring unit relating to ambient parameters, wherein the at least one measuring unit is used to detect, as ambient parameter, preferably a parameter selected from the group consisting of the time of year, time of day, ambient temperature, location, weather, traffic situation in the vicinity of the beverage dispenser and combinations of these parameters. Particularly preferably, all of these parameters are detectable.

A preferred variant provides for the beverage maker to have an evaluation unit for the AI-supported setting and/or for the prediction based on mathematical calculations, in particular on the basis of weighted averaging, which evaluation unit communicates with the measuring unit and evaluates the data transmitted by the measuring unit and uses it to determine the quantity of new beverage to be brewed. It is thus preferred that the evaluation unit of the beverage maker is strctured (respectively configured) such that it evaluates the data transmitted by the detection unit and evaluates the data transmitted by the measuring unit and determines therefrom (i.e., from the evaluated data of the detection unit and the measuring unit) the quantity of new beverage to be brewed.

The subject matter according to the invention will be explained in greater detail on the basis of the following examples and figures, without wishing to limit these to the specific embodiments shown here.

### Example 1

The user selects an even compromise of the modes by setting all 3 modes to medium. For example, a 4 L storage container may be filled with 2 L to ensure a compromise between fresh mode and full load mode. After 1 hour, depending on the fill level, it is then re- brewed to 2 L or a partial quantity is drained and then re-brewed to 2 L in order to achieve a freshness factor that corresponds to a storage time of 30 minutes.

If a large coffee requirement with a high extraction frequency is expected due to the user profile, the machine may be filled with 3 L, for example, allowing larger re-brewing batches or re-brewing at shorter intervals.

### Example 2

The coffee machine is operated in a restaurant with a beer garden, although the beer garden was closed for a few days due to bad weather. The filling and filling quantities of the storage container are controlled with rolling user profiles adapted to previous usage. If the outdoor eating area is opened, this may be set by the user. This means that the previous user profiles are not used to control the storage container, but the user profiles determined in the past for the restaurant with the beer garden.

A similar application is conceivable for a service station, for example, which has an increased number of customers during the vacation season, in contrast to normal operating days.

### Example 3

The user selects a setting of 60% performance (performance factor) and 70% freshness (minimum freshness level). The coffee machine cyclically analyzes the expected beverage quantities for the coming period using a moving average. These quantities are offset against the performance factor and the coffee machine provides a quantity of beverage in the storage container that is adapted to demand. At the same time, the coffee machine analyzes the prevailing freshness in the storage container; if this falls below the minimum freshness of 70% set by the customer, the storage container is partially emptied and fresh coffee is brewed in the storage container. The cyclical, e.g., hourly, analysis of the beverage requirement means that a larger quantity of coffee is automatically kept in the storage container at peak times, resulting in high availability and performance. At less busy times, the quantity stored is automatically reduced in order to reduce the quantity to be disposed of and increase freshness.

1. A beverage maker with controllable operation, comprising
a) a brewing unit,
b) a storage container for at least one beverage,
c) at least one detection unit for detecting a fill level in the storage container, a quantity of beverage brewed in the brewing unit and/or a quantity of beverage consumed by the user,
d) an evaluation unit which communicates with the at least one detection unit and is configured such that it evaluates the data transmitted by the detection unit and determines therefrom the quantity of new beverage to be brewed, and
e) a control unit for controlling the quantity of beverage to be brewed in the brewing unit to the desired filling quantity in the storage container based on the evaluation result of the evaluation unit.

2. The beverage maker according to claim 1, characterized in that the at least one detection unit
i) comprises or consists of an active sensor system, wherein the active sensor system is preferably selected from the group consisting of fill level sensors, fill level probes and combinations thereof; and/or
ii) comprises or consists of a passive sensor system which is based on a calculation, wherein the passive sensor system is preferably configured to calculate a quantity of beverage flowing into the storage container and/or flowing out of the storage container, wherein the passive sensor system is particularly preferably configured to calculate a first mathematical product from an opening duration of a first valve of the beverage maker and a first volume flow of beverage through the first valve into the storage container, and to calculate a second mathematical product from an opening duration of a second valve of the beverage maker and a second volume flow of beverage through the second valve out of the storage container, wherein the passive sensor system is configured in particular to determine a quantity of beverage available in the storage container from a difference between the first and second mathematical products.

3. The beverage maker according to any one of claim 1 or 2, characterized in that the control unit is formed in such a way that various basic settings are stored in the control unit, wherein these basic settings may be manually changed with regard to selectable parameters and may be set as at least one operating mode by a user.

4. The beverage maker according to claim 3, characterized in that the selectable parameters comprise values which directly or indirectly indicate a performance, a coffee quality and a coffee waste, wherein, as the at least one operating mode, an operating mode may be set which is selected from the group consisting of full load mode, fresh mode and efficiency mode, wherein transition modes may also be set between these operating modes, and wherein the fresh mode in particular comprises mixing an older brewing batch located in the storage container with freshly brewed beverage.

5. The beverage maker according to any one of claims 1 to 4, characterized in that the beverage maker, preferably the evaluation unit of the beverage maker, based on previous consumption values in relation to a quantity of a beverage consumed by the user, generates an AI-supported prediction of future consumption values in relation to a quantity of a beverage consumed by the user, and/or in that by the beverage maker, preferably by the evaluation unit of the beverage maker, a prediction of future consumption values in relation to a quantity of a beverage consumed by the user is made on the basis of mathematical calculations, in particular on the basis of weighted averaging, wherein the future consumption values are generated as a function of measurement data from at least one measuring unit relating to ambient parameters, wherein the at least one measuring unit is preferably configured such that, as an ambient parameter, a parameter selected from the group consisting of season, day of the week, date, time, ambient temperature, location, weather, traffic situation in the vicinity of the beverage maker, and combinations of these parameters is/are detectable.

6. The beverage maker according to claim 5, characterized in that the evaluation unit of the beverage maker communicates with the measuring unit and is configured such that it evaluates the data transmitted by the detection unit and evaluates the data transmitted by the measuring unit and determines therefrom the quantity of new beverage to be brewed.

7. The beverage maker according to any one of claims 1 to 6, characterized in that the storage container has an insulation, and is arranged in the beverage maker or is connected to the beverage maker as an external storage container.

8. A method for controlling the operation of a beverage maker comprising
a) a brewing unit,
b) a storage container for at least one beverage,
c) at least one detection unit for detecting a fill level in the storage container, a quantity of beverage brewed in the brewing unit and/or a quantity of beverage consumed by the user,
d) an evaluation unit communicating with the at least one detection unit, and
e) a control unit for controlling the quantity of beverage to be brewed in the brewing unit,
wherein the evaluation unit evaluates the data transmitted by the detection unit and uses it to determine the quantity of new beverage to be brewed, and the control unit adjusts the quantity of beverage to be brewed in the brewing unit to a desired filling quantity in the storage container based on the evaluation result of the evaluation unit.

9. The method according to claim 8, characterized in that various basic settings are stored in the control unit, wherein these basic settings are preferably changed by the user with regard to selectable parameters and are set as at least one operating mode.

10. The method according to claim 9, characterized in that an operating mode which is selected from the group consisting of full load mode, fresh mode and efficiency mode is set as the at least one operating mode, wherein preferably transition modes are also set between these operating modes, and wherein the fresh mode in particular comprises mixing an older brewing batch located in the storage container with freshly brewed beverage.

11. The method according to any one of claims 8 to 10, characterized in that the beverage maker, preferably the evaluation unit of the beverage maker, based on previous consumption values in relation to a quantity of a beverage consumed by the user, generates an AI-supported prediction of future consumption values in relation to a quantity of a beverage consumed by the user, or in that, by the beverage maker, preferably by the evaluation unit of the beverage maker, a prediction of future consumption values in relation to a quantity of a beverage consumed by the user is made on the basis of mathematical calculations, for example a weighted averaging, wherein the future consumption values are generated as a function of measurement data from at least one measuring unit relating to ambient parameters, wherein the at least one measuring unit preferably detects, as an ambient parameter, a parameter selected from the group consisting of the time of year, day of the week, date, time, ambient temperature, location, weather, traffic situation in the vicinity of the beverage maker, and combinations of these parameters.

12. The method according to claim 11, characterized in that the evaluation unit communicates with the measuring unit and evaluates the data transmitted by the detection unit and evaluates the data transmitted by the measuring unit and determines therefrom the quantity of new beverage to be brewed.
